(19) United States
(12) Patent Application Publication
(10) Pub. No.: US 2011/0253043 A1
(43) Pub. Date: Oct. 20, 2011

(54) Nozzle, Substrate Processing Apparatus Including The Nozzle, And Processing Solution Supply Method Using The Apparatus

(75) Inventors: Seongyoon KIM, Hwaseong-si (KR); Chanuk JEON, Gyeonggi-do (KR); Inkyun SHIN, Yongin-si (KR)

(73) Assignee: SAMSUNG ELECTRONICS CO., LTD., Suwon-si (KR)

(21) Appl. No.: 13/049,336

(22) Filed: Mar. 16, 2011

(30) Foreign Application Priority Data
Apr. 19, 2010 (KR) 10-2010-0035980

(51) Int. Cl. B05C 11/00

(52) U.S. Cl. 118/663

(57) ABSTRACT

In one embodiment, the nozzle includes a first body having an open lower surface and a plurality of buffer spaces to store a processing solution therein. A first shutter is disposed at a lower part of the first body to selectively open and close lower surfaces of the buffer spaces, and a driving unit configured to move the first shutter or the first body so that a position of the first shutter is varied relative to the buffer spaces.

### CROSS-REFERENCE TO RELATED APPLICATIONS

This U.S. non-provisional patent application claims priority under 35 U.S.C. §119 of Korean Patent Application No. 10-2010-0035980, filed on Apr. 19, 2010, the entire contents of which are hereby incorporated by reference.

### BACKGROUND

The present disclosure herein relates to a substrate processing apparatus and method and more particularly, to an apparatus and method of supplying a processing solution to a substrate.

When manufacturing a semiconductor integrated circuit (IC), a photo mask is used for pattern transfer in an exposure process. A pattern formed on the photo mask is reduction-projected on an exposure-object substrate such as a wafer or a glass plate, through a reduction projection optical system. The photo mask used for the pattern transfer is also called a reticle.

A nozzle is used to inject a developer onto the photo mask during manufacturing of the photo mask. The developer process may be affected by a injection state of the nozzle and an injection quantity of the processing solution. Also, the processing solution process influences a photo mask critical dimension.

### SUMMARY

The present disclosure provides an improved apparatus and method of supplying a processing solution.

The present disclosure also provides an apparatus and method capable of supplying a processing solution uniformly to a substrate.

The present disclosure also provides an apparatus and method capable of controlling a supply quantity of a processing solution according to regions of the substrate.

One embodiment of a nozzle includes a first body having an open lower surface a plurality of buffer spaces to store a processing solution. A first shutter is disposed at a lower part of the first body and is configured to selectively open and close lower surfaces of the buffer spaces. A driving unit is configured to move the first shutter or the first body to vary a position of the first shutter relative to the buffer spaces.

In some embodiments, the first shutter may include an opening disposed in a region corresponding to one of the buffer spaces. The first shutter may include a region at one side of the opening, the region having an area equivalent to a cross sectional area of the first body.

In other embodiments, the buffer spaces may be linearly arranged in a first direction, each of the buffer spaces may extend in a second direction, and the second direction may be perpendicular to the first direction such as when seen from the above.

In still other embodiments, the first shutter may be connected to the lower surface of the first body to be movable in the first direction.

In even other embodiments, the nozzle may further include a sub shutter mounted to the first shutter to be movable along the opening, and the sub shutter may have a smaller length than the opening.

In yet other embodiments, the nozzle may further include a first sub shutter mounted to the first shutter and disposed at one side of the opening to be movable along the opening. A second sub shutter may be mounted to the first shutter and disposed at the other side of the opening to be movable along the opening. Here, the first sub shutter and the second sub shutter may have a smaller length than the opening.

In further embodiments, each of the buffer spaces may include a plurality of partitions arranged at intervals in the second direction so that each of the buffer spaces is partitioned into a plurality of spaces.

In still further embodiments, the first body may have an open upper surface, and the nozzle may further include a second body disposed at an upper part of the first body. The second body may comprise an inner space with an open lower surface. A second shutter is disposed between the first body and the second body to seal one of the buffer spaces from the inner space.

In even further embodiments, the first body may have an open upper surface, and the nozzle may further include a second body disposed at an upper part of the first body. The second body may comprise an inner space with an open lower surface. A separator plate may be disposed in the inner space to partition the inner space into a plurality of spaces, and the partitioned spaces may correspond with the buffer spaces.

In yet further embodiments, the nozzle may further include a first sensor disposed in a first position of the first body; a second sensor disposed in a second position of the first body; and a control unit configured to control the driving unit according to a signal received from the sensors. The first position may be disposed at a first interval downward from an upper surface of the first body and the second position may be disposed at a second interval upward from the lower surface of the first body and lower than the first position.

In a further embodiment, the nozzle includes a first body, a first shutter and second shutter. The first body defines at least two internal buffer spaces, and the first body defines a first opening from the buffer spaces and a second opening to the buffer spaces. The first shutter is configured to selectively open and close at least a portion of the first opening to the buffer spaces. The second shutter is configured to selectively open and close at least a portion of the second opening to the buffer spaces.

In one embodiment, a substrate processing apparatus includes a support member configured to support a substrate; a nozzle configured to supply a processing solution to the substrate; and a nozzle moving member configured to move the nozzle. The nozzle comprises a first body having an open lower surface and a plurality of buffer spaces linearly arranged in a first direction to store a processing solution; a first shutter disposed at a lower part of the first body while comprising an opening corresponding to one of the buffer spaces and is configured to selectively open and close lower surfaces of the buffer spaces; and a driving unit configured to move the first shutter or the first body in the first direction to vary a position of the first shutter relative to the buffer spaces.

In some embodiments, the buffer spaces may extend in a second direction which is perpendicular to the first direction as seen from the above, and the first shutter may be connected to the lower surface of the first body to be movable in the first direction.

In other embodiments, the first body may have an open upper surface, and the nozzle may include a second body disposed at an upper part of the first body. The second body may comprise an inner space with an open lower surface. A second shutter is disposed between the first body and the second body and is configured to seal one of the buffer spaces from the inner space by moving in the first direction.

In still other embodiments, the substrate processing apparatus may further include a first sensor disposed at a first interval downward from an upper surface of the first body; a second sensor disposed at a second interval upward from the lower surface of the first body; and a control unit configured to control the driving unit according to a signal received from the first and the second sensors.

In one embodiment, a processing solution supply method includes opening a lower surface of a first buffer space which is one of a plurality of buffer spaces formed in a nozzle, to supply a processing solution to an object. The method further includes closing the lower surface of the first buffer space while opening a lower surface of a second buffer space after supply of the processing solution from the first buffer space is completed, thereby continuing supply of the processing solution to the object.

In some embodiments, the nozzle may move over an upper part of the object in a scanning manner.

In other embodiments, the lower surface of the first buffer space may be closed when a water level of the processing solution left in the first buffer space reaches a desired height from a lower surface of the first buffer space.

In still other embodiments, the processing solution may be supplied to the first buffer space while the processing solution is being supplied from the second buffer space.

In even other embodiments, the object may be a reticle and the processing solution is a developer.

### BRIEF DESCRIPTION OF THE DRAWINGS

The accompanying drawings are included to provide a further understanding of the inventive concepts, and are incorporated in and constitute a part of this specification. The drawings illustrate exemplary embodiments of the inventive concepts and, together with the description, serve to explain principles of the inventive concepts. In the drawings:

FIG. 1 is a plan view schematically showing a substrate processing apparatus according to an embodiment of the inventive concepts;

FIG. 2 is a sectional view of the substrate processing apparatus of FIG. 1;

FIG. 3 is a perspective view of a nozzle according to the embodiment;

FIG. 4 is an exploded perspective view of the nozzle of FIG. 3;

FIG. 5 is a sectional view of the nozzle of FIG. 3;

FIG. 6 is a view showing a connection state of a first body and a first shutter of the substrate processing apparatus according to the embodiment;

FIGS. 7 through 9 are views showing the process of supplying a processing solution according to the embodiment;

FIG. 10 is a sectional view of a nozzle according to another embodiment of the inventive concepts;

FIG. 11 is a sectional view of a nozzle according to still another embodiment of the inventive concepts;

FIG. 12 is a perspective view of a modified version of the first shutter according to the embodiment;

FIG. 13 is a plan sectional view of the nozzle attached with the first shutter of FIG. 12; and

FIG. 14 is a perspective view of another modified version of the first shutter according to the embodiment.

### DETAILED DESCRIPTION OF THE EMBODIMENTS

Example embodiments of the inventive concepts will be described below in more detail with reference to the accompanying drawings. The inventive concepts may, however, be embodied in different forms and should not be construed as limited to the example embodiments set forth herein. Rather, these example embodiments are provided so that this disclosure will be thorough and complete, and will fully convey the scope of the inventive concepts to those skilled in the art.

In the specification, it will be understood that when a layer (or film) is referred to as being ‘on’ another layer or substrate, it can be directly on the other layer or substrate, or intervening layers may also be present. Also, in the figures, the dimensions of layers and regions are exaggerated for clarity of illustration. Also, though terms like a first, a second, and a third are used to describe various regions and layers in various example embodiments the regions and the layers are not limited to these terms. These terms are used only to discriminate one region or layer from another region or layer. Therefore, a layer referred to as a first layer in one example embodiment can be referred to as a second layer in another example embodiment. An example embodiment described and exemplified herein includes a complementary embodiment thereof. In the specification, the term ‘and/or’ is used as meaning in which the term includes at least one of preceding and succeeding elements. Like reference numerals refer to like elements throughout.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present inventive concepts. As used herein, the singular fain s “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to longitudinal sectional illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the present inventive concepts.

Unless otherwise defined, all terms (including technical and scientific terms) used herein have the same meaning as commonly understood by one of ordinary skill in the art to which the inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

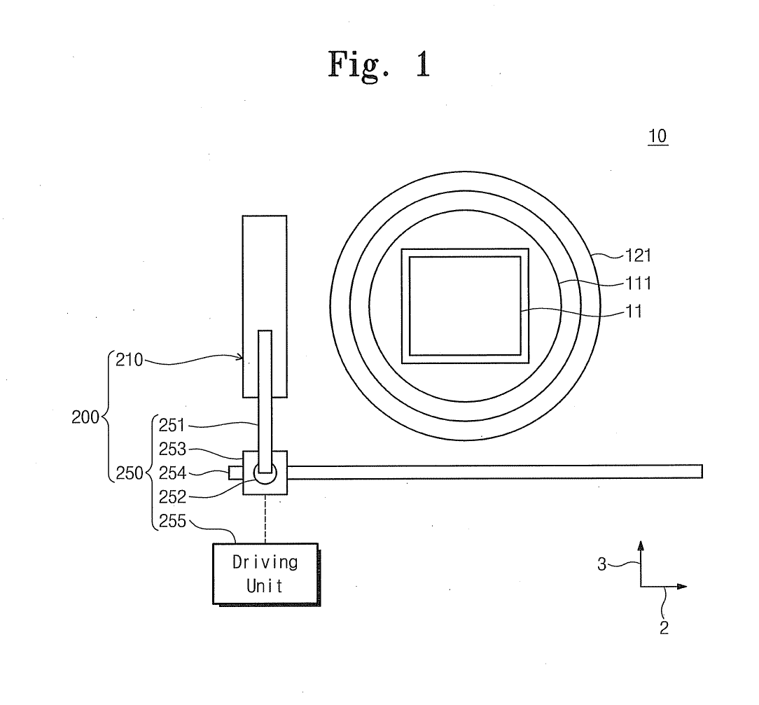

Exemplary embodiments of the inventive concepts will be described below in more detail with reference to FIGS. 1 through 14. The inventive concepts may, however, be embodied in different forms and should not be construed as limited to the embodiments set forth herein. Rather, these embodiments are provided so that this disclosure will be thorough and complete, and will fully convey the scope of the inventive concepts to those skilled in the art. Therefore, shapes of elements may be exaggerated in the drawings.

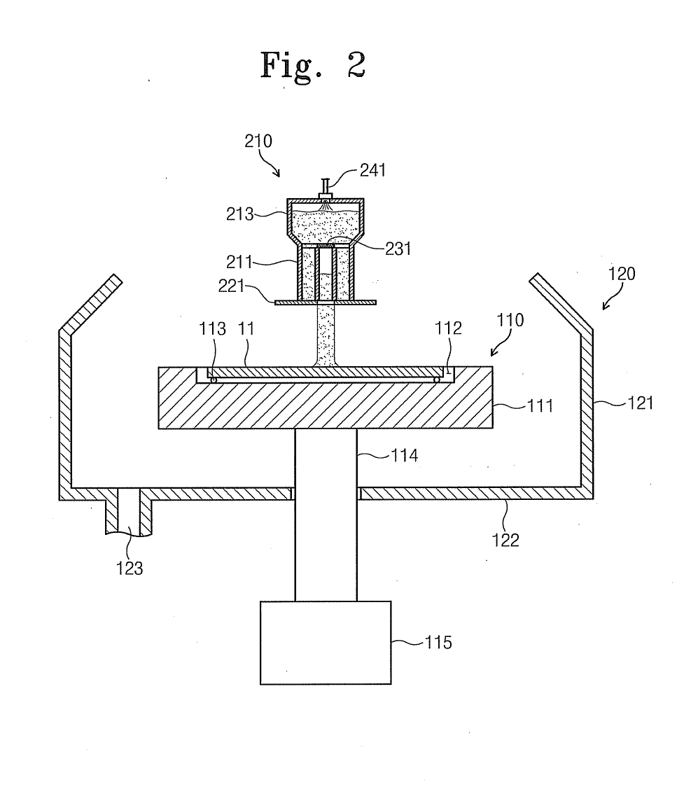

FIG. 1 is a plan view schematically showing a substrate processing apparatus according to an embodiment of the inventive concepts. FIG. 2 is a sectional view of the substrate processing apparatus of FIG. 1.

Referring to FIGS. 1 and 2, a substrate processing apparatus 10 includes a support member 110, a container 120, and a processing solution supply member 200. The support member 110 supports the substrate 11. The container 120 receives a processing solution supplied to the substrate 11. The processing solution supply member 200 supplies the processing solution to the substrate 11. The structural elements will be described in further detail.

The support member 110 includes a support plate 111, a support projection 113, a support shaft 114, and a driving unit 115.

The support plate 111 is configured to support the substrate 11 by having a disc shape. A depression 112 is formed on an upper surface of the support plate 111. The depression 112 is disposed in the center of the upper surface of the support plate 111 and has a larger area than the substrate 11. According to the embodiment, the depression 112 may have a substantially rectangular shape as seen from the above.

The support projection 113 is formed on a lower surface of the depression 112. A plurality of the support projections 113 having a substantially spherical shape may be arranged on the lower surface at intervals. The substrate 11 is placed on upper ends of the support projections 113. In the present embodiment, four support projections 113 are provided to support four corners of the substrate 11. An upper surface of the substrate 11 supported by the support projections 13 is disposed at the same height as the upper surface of the support plate 111.

The support shaft 114 is disposed at a lower part of the support plate 111 to support the support plate 111. The support plate 114 may be formed as a hollow shaft and configured to transmit a rotational force generated from the driving unit 115 to the support plate 111.

The driving unit 115 is disposed at a lower end of the support shaft 114. The driving unit 115 is configured to generate the rotational force to rotate the support shaft 114.

The container 120 prevents leakage of the processing solution supplied to the substrate 11.

More specifically, the container 120 has an open upper part and contains a space therein for processing the substrate 11. The container 120 is constituted by a bottom wall 122 disposed under the support plate 111 and a sidewall 121 extending upward from a periphery of the bottom wall 122 and surrounding the support plate 111. The bottom wall 122 includes an insertion hole for the support shaft 114. In addition, the bottom wall 122 includes a collecting hole 123 through which the processing solution received in the container 120 is collected to a forwarding line (not shown).

According to the present embodiment, the container 120 or the support plate 111 may be moved up and down so that a height of the container 120 is varied relative to a height of the support plate 111.

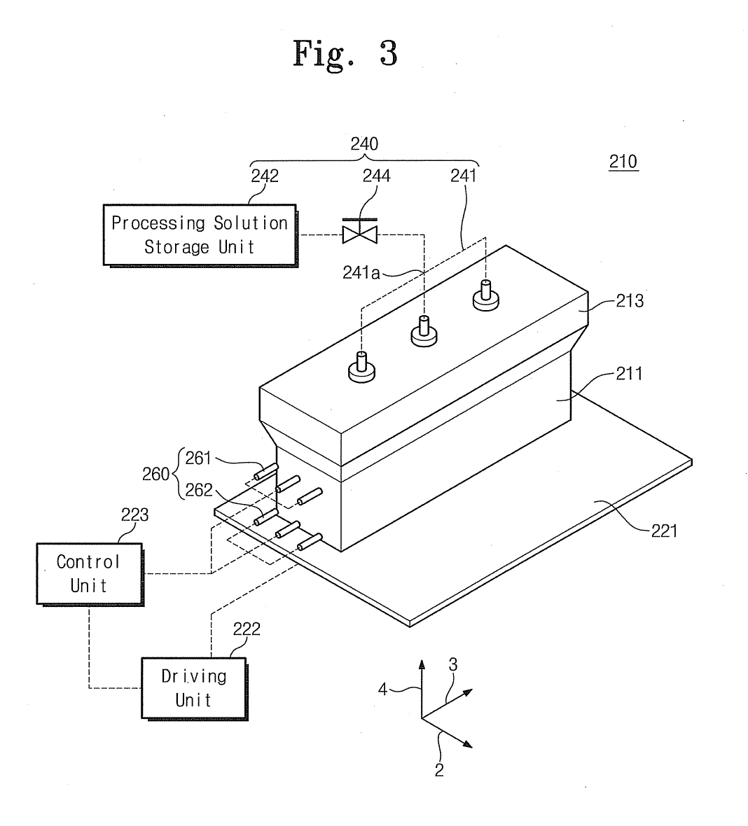

The processing solution supply member 200 supplies the processing solution to the substrate 11 supported by the support plate 111. For this, the processing solution supply member 200 includes a nozzle 210, a processing solution supply unit 240 (FIG. 3), and a nozzle moving member 250. The nozzle 210 supplies the processing solution to the substrate 11. The nozzle moving member 250 moves the nozzle 210. The processing solution supply unit 240 supplies the processing solution to the nozzle 210. Hereinafter, the respective parts will be described in detail.

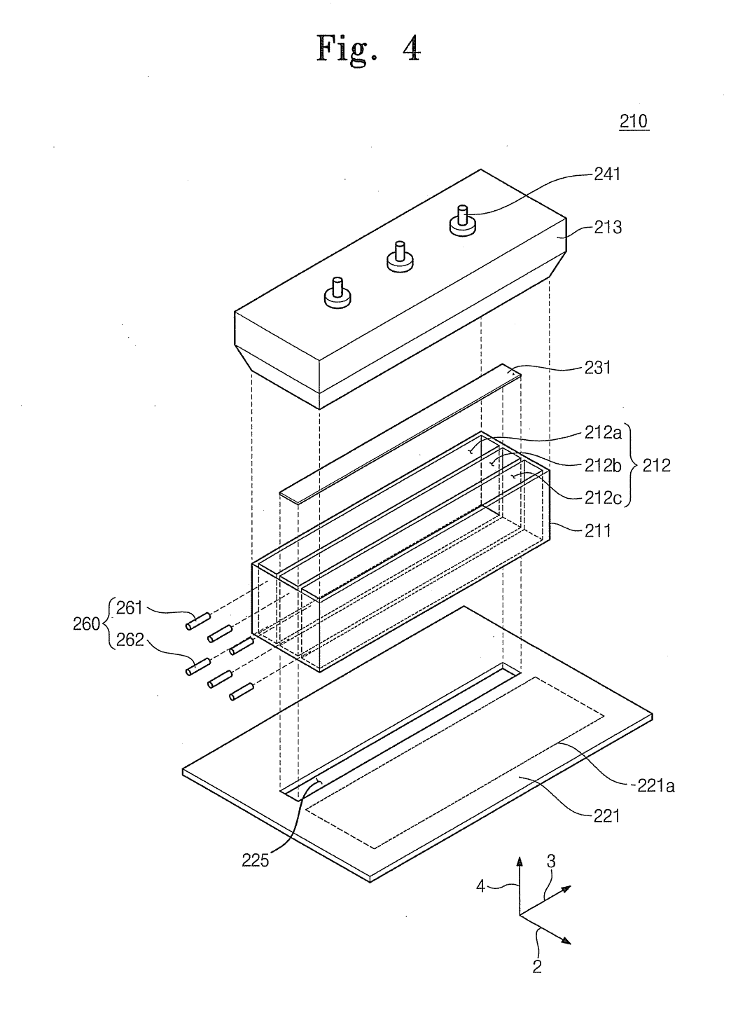

FIG. 3 is a perspective view of a nozzle according to the embodiment. FIG. 4 is an exploded perspective view of the nozzle of FIG. 3. FIG. 5 is a sectional view of the nozzle of FIG. 3.

Referring to FIGS. 3 to 5, the nozzle 210 supplies the processing solution to the substrate 11. For this, the nozzle 210 includes a first body 211, a second body 213, a first shutter 221, a driving unit 222, a second shutter 231, and a plurality of sensors 260.

The first body 211 has a substantially rectangular box shape. Upper and lower surfaces of the first body 211 are open and the interior of the first body defines a plurality of separate buffer spaces 212. The buffer spaces 212 are configured to store the processing solution. According to the embodiment, the buffer spaces 212 are linearly arranged. The arrangement direction of the buffer spaces 212 will be referred to as a first direction 2 whereas a length direction of each buffer space 212 will be referred to as a second direction 3. When seen from the above, the second direction 3 is perpendicular to the first direction 2. In addition, a third direction 4 is perpendicular to both the first and the second directions 2 and 3. The first body 211 extends longer in the second direction 3 than in the first direction 2. In the present embodiment, the first body 211 includes three buffer spaces 212a to 212c arranged sequentially in the first direction 2. However, not limited thereto, two or four buffer spaces may be provided in the first body 211.

The second body 213 is disposed at an upper part of the first body 211. The second body 213 includes an inner space 214 which is opened downward (i.e., at an interface with the first body 211). The second body 213 is constituted by an upper wall 213a and a sidewall 213b. The upper wall 213a is formed as a substantially rectangular plate. The sidewall 213b extends downward from a periphery of the upper wall 213a. In the present embodiment, the sidewall 213b may incline toward a center of the second body 213 from an upper end to a lower end thereof. A feed line 241 is connected to the upper wall 213a. The lower end of the sidewall 213b is connected to an upper end of the first body 211. The second body 213 temporarily stores the processing solution supplied to the inner space 214 through the feed line 241. The processing solution stored in the inner space 214 is supplied to the buffer spaces 212 of the first body 211.

The first shutter 221 is disposed at a lower part of the first body 211 and is formed as a rectangular plate having a larger cross section than the first body 211. The first shutter 221 includes an opening 225 disposed in a region corresponding to one of the buffer spaces 212, for example, a buffer space 212b. The opening 225 extends in the second direction 3. The first shutter 221 may include a region 221 a disposed at one side of the opening 225 and having an area equivalent to or greater than a cross sectional area of the first body 211.

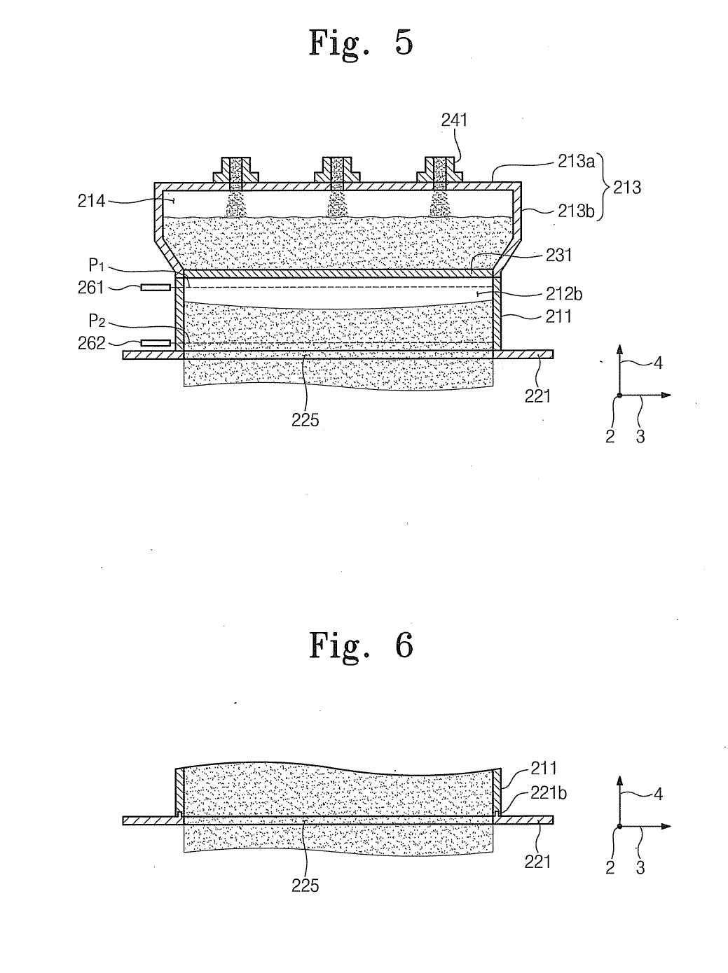

The first shutter 221 is connected to the lower surface of the first body 211 to be movable in the first direction 2. For example, as shown in FIG. 6, guide rails 221b may be formed parallel on both sides of the opening 225 in the first direction 2. Additionally, grooves may be formed in the first direction 2 on both sides of a lower end of the first body 211 to receive the guide rails 221b. The first shutter 221 may move in the first direction 2 as the guide rails 221b move along the grooves.

The driving unit 222 moves the first shutter 221 or the first body 211 to vary the position of the first shutter 211 relative to the buffer spaces 212. According to the present embodiment, the driving unit 222 moves the first shutter 221 in the first direction 2.

According to the structure of the first body 211, the first shutter 221, and the driving unit 222, the first shutter 221 selectively opens and closes lower surfaces of the buffer spaces 212. More specifically, as the opening 225 is moved in the first direction 2 to be disposed at a lower part of any one of the first to the third buffers spaces 212a to 212c, the first shutter 221 is capable of opening and closing the lower surfaces of the buffer spaces 212. In addition, as the first shutter 221 is moved such that the lower surfaces of the buffer spaces 212 are disposed all in the region 221a formed at one side of the opening 225, all the lower surfaces of the buffer spaces 212 may be closed.

The second shutter 231 is disposed between the first body 211 and the second body 213. The second shutter 231 has a rectangular plate shape extending in the second direction 3 and having the same length as the buffer spaces 212. The second shutter 231 has a width corresponding to a width of one buffer space 212 in the first direction 2. The second shutter 231 is moved in the first direction 2 by the driving unit 222. According to the above structure, the second shutter 231 selectively seals off one of the buffer spaces 212, for example the buffer space 212b, and the inner space 214. In the present embodiment, if the second shutter 231 seals the buffer space 212b, which supplies the processing solution to the substrate 11 by being opened at a lower surface by the first shutter 221, then the processing solution stored in the inner space 214 is not supplied to the buffer space 212b. On the other hand, the buffer spaces 212a and 212c not sealed by the second shutter 231 with respect to the inner space 214 are supplied with the processing solution.

The sensors 260 are provided at one side of the first body 211. In the present embodiment, each of the buffer spaces 212 includes a pair of sensors 261 and 262 at one side thereof. The first sensor 261 is disposed in a first position, which is at a desired (or, alternatively predetermined) interval downward from the upper end of the first body 211. The first sensor 261 determines a minimum required quantity of the processing solution to fill a buffer space 212. That is, the first sensor 261 measures whether the processing solution is supplied to a higher position than the first position P1 in the buffer space 212. When the processing solution is stored up to the first position P1 or more in the buffer space 212, the buffer spaces 212 are able to supply the processing solution sufficiently and uniformly in the second direction 2.

The second sensor 262 is disposed in a second position P2, which is at a desired (or, alternatively predetermined) interval upward from the lower end of the first body 211 and is lower than the first position P1. The second sensor 262 determines a water level of the processing solution required to close the lower surfaces of the buffer spaces 212. That is, the second sensor 262 measures whether the water level of the processing solution injected from the buffer spaces 212 is disposed lower than the second position P2. When the water level of the processing solution is lower than the second position P2, the lower surfaces of the buffer spaces 212 are closed. Due to surface tension, the surface of the processing solution is higher at a periphery than in the center of the buffer space 212 with respect to the second direction 3. Therefore, quantities of the processing solution supplied from different regions of the buffer spaces 212 varies according to regions of the substrate 11. However, the second sensor 262 controls the quantity of the processing solution supplied to the substrate 11 such that an upper part of the processing solution, which is varied in height according to regions, is not supplied to the substrate 11. Accordingly, the processing solution may be uniformly supplied to the overall region of the substrate 11.

A control unit 223 receives signals from the first and the second sensors 261 and 262 and accordingly controls the driving unit 222. According to the present embodiment, the control unit 223 controls whether to close the lower surfaces of the buffer spaces 212 in accordance with the signal from the second sensor 262. When the signal from the second sensor 262 indicates that the water level of the processing solution is lower than the second position P2, the control unit 233 controls the driving unit 222 to close the lower surfaces of the buffer spaces 212. In addition, the control unit 233 measures the quantity of the processing solution supplied to the buffer spaces 212 in accordance with the signal from the first sensor 261. When the signal from the first sensor 261 indicates that the processing solution is supplied to more than the first position P1, the control unit 223 determines that the processing solution is supplied enough to open the lower surfaces of the buffer spaces 212. When the signal from the second sensor 262 indicates that the water level of the processing solution is lower than the second position P2, the control unit 223 controls the driving unit 222 to close the lower surface of the buffer space 212 of which the first sensor 261 signaled that the lower surface can be opened.

Referring back to FIG. 1, the nozzle moving member 250 is disposed at one side of the container 120 and moves the nozzle 210 in the first direction 2. The nozzle moving member 250 includes a support rod 251, a support shaft 252, a moving plate 253, a guide rail 254, and a driving unit 255.

The support rod 251 has a rod shape configured to support the nozzle 210. The support rod 251 is disposed at an upper part of the nozzle 210 in the second direction 3. One end of the support rod 251 is connected with the nozzle 210 while the other end is connected with the support shaft 252.

The support shaft 252 is disposed vertically at a lower part of the support rod 251. The support shaft 252 has an upper end connected to the other end of the support rod 251 and supports the support rod 251

The moving plate 253 is connected with a lower end of the support shaft 252. The moving plate 253 is movable in the first direction 2 along the guide rail 254 which is driven by the driving unit 255.

The guide rail 254 is disposed in the first direction 2 to guide the movement of the moving plate 253.

According to the structure of the nozzle moving member 250, the nozzle 210 is capable of moving over an upper part of the substrate 11. According to the present embodiment, the nozzle 210 supplies the processing solution to the substrate 11 by moving in a scanning manner from one end to the other end of the substrate 11 in the first direction 2.

Referring back to FIG. 3, the processing solution supply unit 240 supplies the processing solution to the nozzle 210. For this purpose, the processing solution supply unit 240 includes the feed line 241, a processing solution storage unit 242, and a valve 244.

The processing solution stored in the processing solution storage unit 242 is supplied to the nozzle 210 through the feed line 241. The feed line 241 is connected to the processing solution storage unit 242 by one end thereof and to the second body 213 by the other end thereof. According to the present embodiment, the other end of the feed line 241 is branched into three branches spaced from one another in the second direction 3 and connected to the second body 213. The valve 244 is mounted on the feed line 241 to adjust a flow quantity of the processing solution supplied through the feed line 241. According to the embodiment, the valve 244 is mounted between the processing solution storage unit 242 and the branching position 241a of the feed line 241.

Hereinafter, a method of supplying the processing solution using the above-structured substrate processing apparatus will be described.

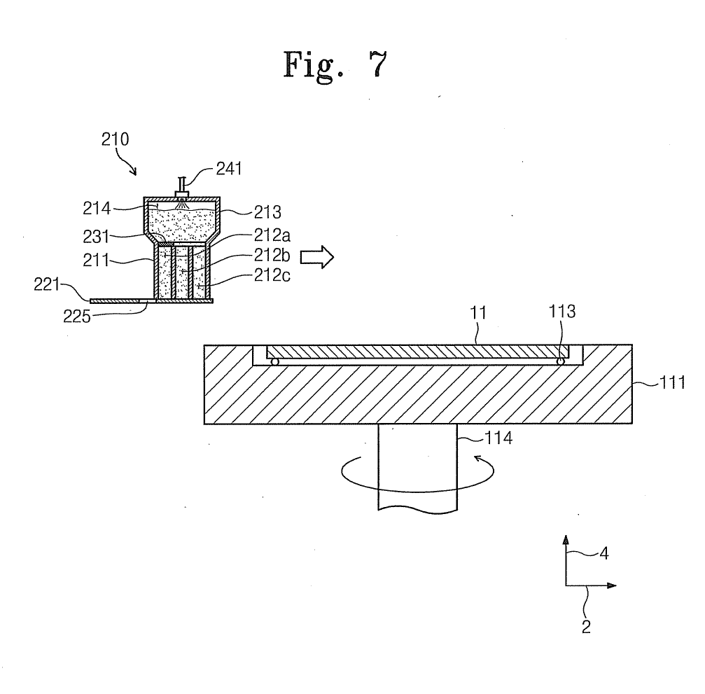

FIGS. 7 through 9 are views showing processes of supplying a processing solution according to the embodiment.

As shown in FIG. 7, the first shutter 221 is moved such that the first to the third buffer spaces 212a to 212c are disposed at one side of the opening 225 and therefore the lower surfaces of the first to the third buffer spaces 212a to 212c are sealed or shut. The processing solution is supplied to and stored in the first to the third buffer spaces 212a to 212c. In this state, the nozzle 210 advances to an upper part of an object 11. The object 11 refers to an object to be processed by the processing solution. The object 11 may be a substrate, a reticle, etc.

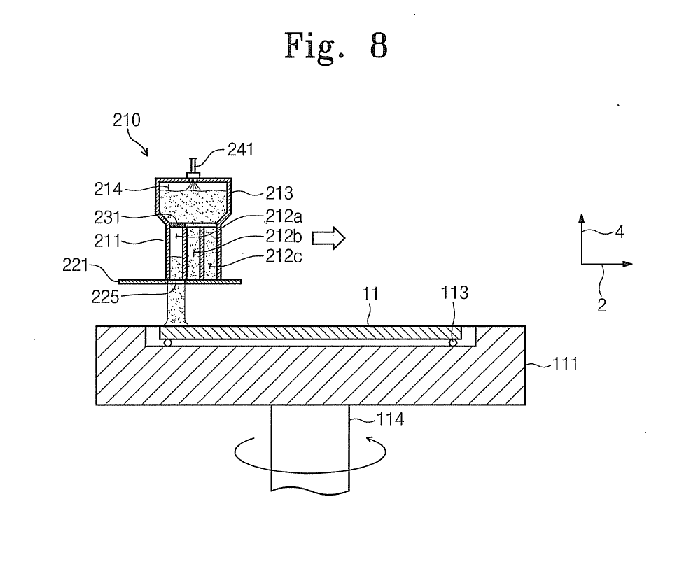

While moving in the first direction 2, the nozzle 210 supplies the processing solution sequentially from the first to the third buffer spaces 212a to 212c to the object 11. Referring to FIG. 8, as the nozzle 210 advances to the upper part of the object 11, the first shutter 221 is moved so that the opening 225 is disposed at a lower part of the first buffer space 212a. The processing solution stored in the first buffer space 212a is supplied to the object 11 through the opening 225. During the supply of the processing solution from the first buffer space 212a, the second shutter 213 shuts between the first buffer space 212a and the inner space 214. Therefore, supply of the processing solution is prevented from flowing to the first buffer space 212a from the inner space 214.

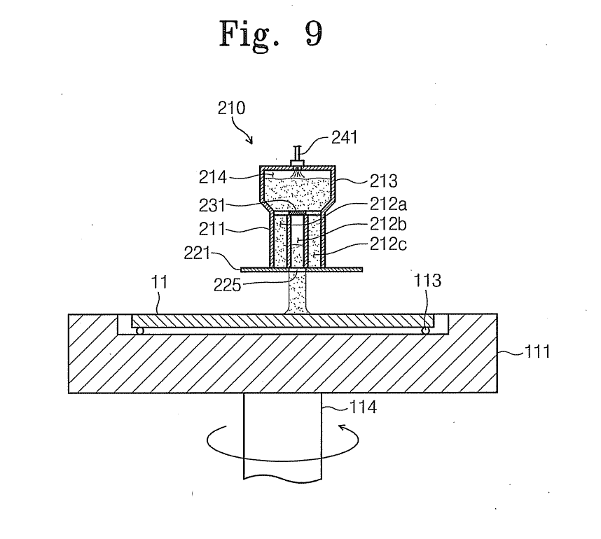

When the water level of the processing solution stored in the first buffer space 212a is lower than the second position P2 (FIG. 5), the first shutter 221 is moved in the first direction 2. Referring to FIG. 9, the first shutter 221 is moved such that the opening 225 is disposed at a lower part of the second buffer space 212b and therefore the lower surface of the second buffer space 212b is opened. The processing solution in the second buffer space 212b is supplied to the object 11 through the opening 225. The second shutter 231 is disposed at an upper part of the second buffer space 212b, thereby sealing the second buffer space 212b from the inner space 214. The first buffer space 212a communicates with the inner space 214 by the movement of the second shutter 231. Accordingly, during supply of the processing solution from the second buffer space 212b, the processing solution stored in the inner space 214 is supplied to the first buffer space 212a. Here, the processing solution is supplied higher than the first position P1 (FIG. 5). When the water level of the processing solution stored in the second buffer space 212b is lower than the second position P2, the first shutter 221 moves in the first direction 2, thereby selectively opening the lower surface of the first buffer space 212a or the third buffer space 212c. When the processing solution supplied to the first buffer space 212a does not reach the first position P1, the third buffer space 212c is opened. On the other hand, when the processing solution supplied to the first buffer space 212a is higher than the first position P1, any of the first buffer space 212a and the third buffer space 212c may be selectively opened.

Closing of the lower surface of the first buffer space 212a and opening of the lower surface of the second buffer space 212b are successively performed. While the lower surfaces of the buffer spaces 212 are being sequentially opened, the nozzle 210 moves over the object 11 in a scanning manner. According to the embodiment, the object 11 may be rotated while the nozzle 210 is supplying the processing solution. According to the above-described method, the processing solution may be uniformly supplied to the object 11 in a length direction of the buffer spaces 212.

In the present embodiment, the processing solution may be a developer.

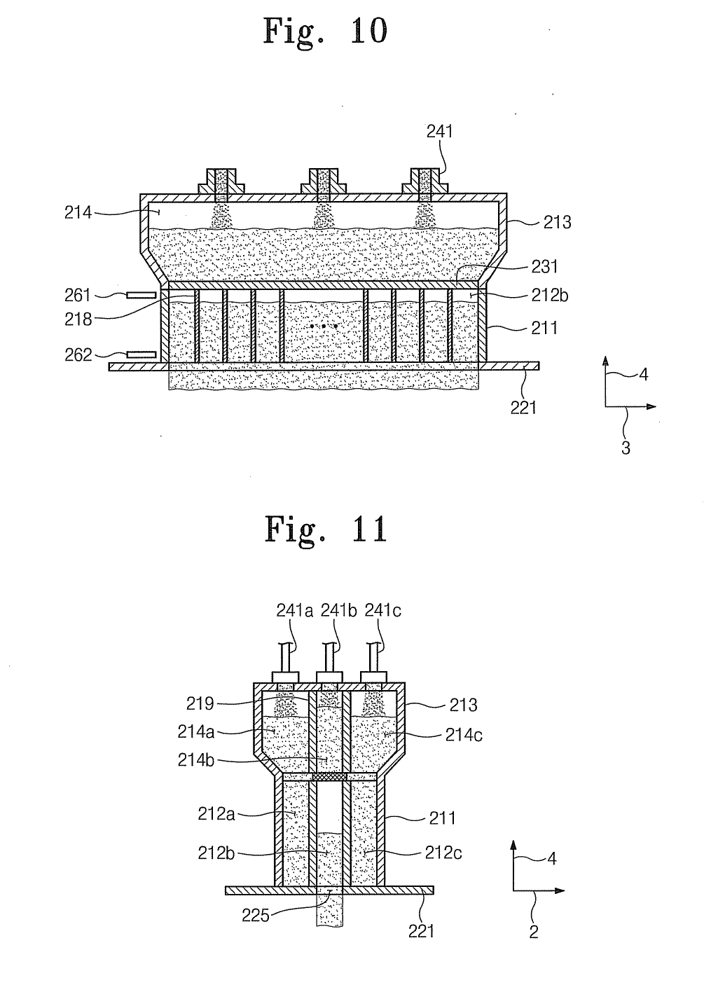

FIG. 10 is a sectional view of a nozzle according to the inventive concepts.

Referring to FIG. 10, the nozzle has the same structure as the nozzle shown in FIG. 5 except that each of the buffer spaces includes partitions 218. The partitions 218 are arranged at intervals in the second direction 3, thereby partitioning each buffer space into a plurality of spaces. The partitions 218 are formed relatively thinner than the sidewall of the first body 211. According to the embodiment, for example, the processing solution is supplied to a buffer space 212 and then supplied to the plurality of partitioned spaces. In addition, when the lower surface of the buffer space 212 is opened, the processing solution is injected from the spaces simultaneously. Since the partitions 218 are thin, the processing solution injected from the plurality of adjoining spaces joins one another and then is supplied to the object. Therefore, the processing solution may be uniformly supplied to the object in a length direction of the second buffer space 212.

FIG. 11 is a sectional view of a nozzle according to still another embodiment of the inventive concepts.

Referring to FIG. 11, the nozzle of the present embodiment has the same structure as the nozzle shown in FIG. 2 except that the inner space 214 of the second body 213 includes a plurality of separator plates 219. The separator plates 219 are arranged at intervals in the first directions 2, thereby partitioning the inner space into a plurality of spaces 214a to 214c. According to the present embodiment, the partitioned inner spaces 214a to 214c correspond to the buffer spaces 212a to 212c in number and correspond to the buffer spaces 212a to 212c, respectively. Namely, inner spaces 214a to 214c have corresponding fluid communication with buffer spaces 212a to 212c. Also, the partitioned inner spaces 214a to 214c are connected with separate feed lines 241a to 241c, respectively, to be supplied with the processing solution.

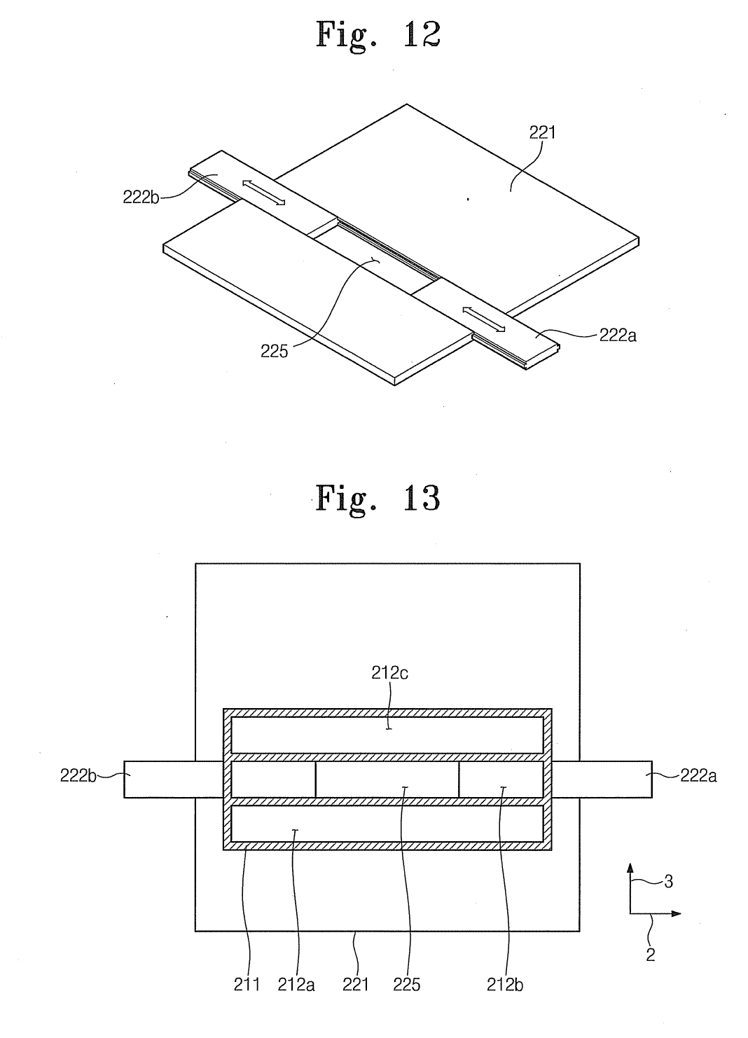

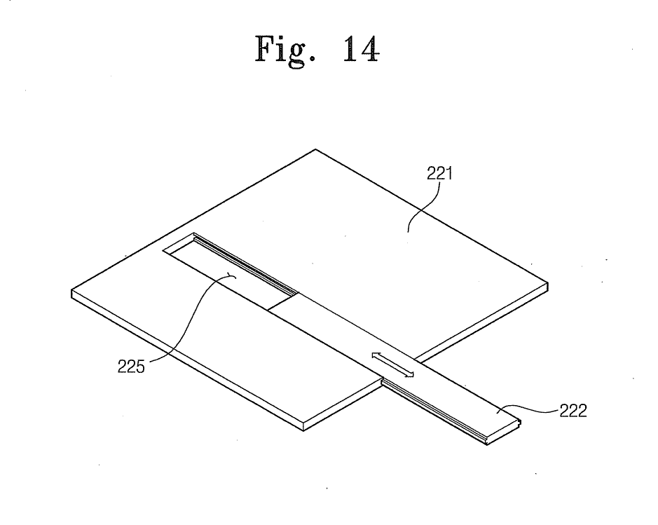

FIG. 12 is a perspective view of a modified version of the first shutter according to the embodiment. FIG. 13 is a plan sectional view of the nozzle attached with the first shutter of FIG. 12.

Referring to FIGS. 12 and 13, the first shutter 221 is structured in the same manner as in FIG. 4. However, differently from the first shutter 221 of FIG. 4, the first shutter 221 of the present embodiment includes a pair of sub shutters, that is, first and second sub shutters 222a and 222b. The first sub shutter 222a is disposed at one side of the opening 225 and is mounted to the first shutter 221 to be movable along the opening 225. The first and the second sub shutters 222a and 222b have a smaller length than the opening 225. The first and the second sub shutters 222a and 222b adjust an open length of the opening 225 by moving in a length direction of the opening 225. Here, the first and the second sub shutters 222a and 222b may move independently or together.

According to the above-structured first shutter 221 and the sub shutters 222a and 222b, a region of the buffer space 212 where the processing solution is supplied may be adjusted in the second direction 3. In a case that different quantities of the processing solution are required for different regions of the object, the first and the second sub shutters 222a and 222b adjust the open length of the opening 225 corresponding to the regions of the object and supply the processing solution through the opening 225.

FIG. 14 is a perspective view of another modified version of the first shutter according to the embodiment. Referring to FIG. 14, the first shutter 221 of the present embodiment is structured in the same manner as the first shutter 221 of FIG. 4. However, differently from the first shutter 221 of FIG. 4, the first shutter 221 of the present embodiment includes one sub shutter 222. The sub shutter 222 is mounted to the first shutter 221 to be movable along the opening 225. The sub shutter 222 may have a smaller length than or the same length as the opening 225. The sub shutter 222 adjusts the open length of the opening 225 in the second direction 3 by moving in the length direction of the opening 225.

According to the embodiment, uniformity of the substrate processing is improved since a processing solution is uniformly supplied to the substrate through the whole region.

In addition, according to the embodiment, a degree of the substrate processing may be controlled since a supplied quantity of a processing solution can be controlled according to regions of the substrate.

The above-disclosed subject matter is to be considered illustrative and not restrictive, and the appended claims are intended to cover all such modifications, enhancements, and other embodiments, which fall within the true spirit and scope of the inventive concepts. Thus, to the maximum extent allowed by law, the scope of the inventive concepts is to be determined by the broadest reasonable and permissible interpretation of the following claims and their equivalents, and shall not be restricted or limited by the foregoing detailed description.

1. A nozzle comprising:
a first body having an open lower surface and comprising a plurality of buffer spaces to store a processing solution;
a first shutter disposed at a lower part of the first body and configured to selectively open and close lower surfaces of the buffer spaces; and
a driving unit configured to move the first shutter or the first body to vary a position of the first shutter relative to the buffer spaces.

2. The nozzle of claim 1, wherein the first shutter comprises an opening disposed in a region corresponding to one of the buffer spaces.

3. The nozzle of claim 2, wherein the first shutter comprises a region at one side of the opening, the region having an area equivalent to or greater than a total cross sectional area of the buffer spaces.

4. The nozzle of claim 2, wherein
buffer spaces are linearly arranged in a first direction,
each of the buffer spaces extends in a second direction, and
the second direction is perpendicular to the first direction.

5. The nozzle of claim 4, wherein the first shutter is connected to the lower surface of the first body to be movable in the first direction.

6. The nozzle of claim 2, further comprising:
a sub shutter mounted to the first shutter to be movable along the opening, and the sub shutter having a smaller length than the opening.

7. The nozzle of claim 2, further comprising:
a first sub shutter mounted to the first shutter and disposed at first side of the opening to be movable along the opening; and
a second sub shutter mounted to the first shutter and disposed at a second side of the opening to be movable along the opening, the second side being opposite the first side,
wherein the first sub shutter and the second sub shutter have a smaller length than the opening.

8. The nozzle of claim 4, wherein each of the buffer spaces comprises a plurality of partitions arranged at intervals in the second direction so that each of the buffer spaces is partitioned into a plurality of spaces.

9. The nozzle of claim 1, wherein
the first body has an open upper surface, and
the nozzle further includes:
a second body disposed at an upper part of the first body and comprising an inner space with an open lower surface; and
a second shutter disposed between the first body and the second body to seal one of the buffer spaces from the inner space.

10. The nozzle of claim 1, wherein
the first body has an open upper surface,
the nozzle further comprises a second body disposed at an upper part of the first body, the second body defining an inner space with an open lower surface, and a separator plate disposed in the inner space to partition the inner space into a plurality of spaces, and
the partitioned spaces correspond with the buffer spaces.

11. The nozzle of claim 1, further comprising:
a first sensor disposed in a first position of the first body;
a second sensor disposed in a second position of the first body; and
a control unit configured to control the driving unit according to a signal received from the sensors,
wherein the first position is disposed at a first interval downward from an upper surface of the first body, and the second position is disposed at a second interval upward from the lower surface of the first body and lower than the first position.

12. A substrate processing apparatus comprising:
a support member configured to support a substrate;
a nozzle configured to supply a processing solution to the substrate; and
a nozzle moving member configured to move the nozzle,
wherein the nozzle includes, a first body having an open lower surface and comprising a plurality of buffer spaces linearly arranged in a first direction to store the processing solution;
a first shutter disposed at a lower part of the first body, the first shutter including an opening, and the first shutter configured to selectively open and close lower surfaces of the buffer spaces; and
a driving unit configured to move the first shutter or the first body in the first direction to vary a position of the first shutter relative to the buffer spaces.

13. The substrate processing apparatus of claim 12, wherein
the buffer spaces extend in a second direction which is perpendicular to the first direction, and
the first shutter is connected to the lower surface of the first body to be movable in the first direction.

14. The substrate processing apparatus of claim 12, wherein
the first body has an open upper surface, and
the nozzle includes,
a second body disposed at an upper part of the first body and comprising an inner space with an open lower surface; and
a second shutter disposed between the first body and the second body and configured to seal one of the buffer spaces from the inner space by moving in the first direction.

15. The substrate processing apparatus of claim 12, further comprising:
a first sensor disposed at a first interval downward from an upper surface of the first body;
a second sensor disposed at a second interval upward from the lower surface of the first body; and
a control unit configured to control the driving unit according to a signal received from the first and the second sensors.

16-20. (canceled)

21. A nozzle, comprising:
a first body, the first body defining at least two internal buffer spaces, the first body defining a first opening from the buffer spaces and a second opening to the buffer spaces;
a first shutter configured to selectively open and close at least a portion of the first opening from the buffer spaces; and
a second shutter configured to selectively open and close at least a portion of the second opening to the buffer spaces.

22. The nozzle of claim 21, further comprising:
a driving unit configured to control a relative position between the first body and the first shutter, and a relative position between the first body and the second shutter.

23. The nozzle of claim 22, further comprising:
a plurality of sensors configured to sense fluid levels in the buffer spaces; and
a controller configured to control the driving unit based on output from the sensors.

24. The nozzle of claim 23, wherein the controller is configured to control the driving unit such that the first shutter permits fluid to flow from a first buffer space and the second shutter prohibits fluid to flow into the first buffer space.

25. The nozzle of claim 24, wherein the controller is configured to control the driving unit such that the first shutter permits fluid to flow from a second buffer space and the second shutter prohibits fluid to flow into the second buffer space if a fluid level of the first buffer space drops below a threshold level,
wherein the controller is further configured to control the driving unit such that the first shutter prohibits fluid to flow from the first buffer space and the second shutter permits fluid to flow into the first buffer space if the fluid level of the first buffer space drops below the threshold level.
